(19) United States
(12) Patent Application Publication
(10) Pub. No.: US 2007/0038607 A1
(43) Pub. Date: Feb. 15, 2007

(54) Method for rating of web sites and retrieval of rated web sites

(76) Inventors: Mark Herman II, Houma, LA (US); Ben Cathers, Oceanside, NY (US)

Correspondence Address: BROMBERG & SUNSTEIN LLP, 125 SUMMER STREET, BOSTON, MA, 02110-1618, US

(21) Appl. No.: 11/398,511

(22) Filed: Apr. 5, 2006

Related U.S. Application Data
(60) Provisional application No. 60/668,409, filed on Apr. 5, 2005.

(51) Int. Cl. G06F 17/30

(52) U.S. Cl. 707/3

(57) ABSTRACT

A method of categorizing and retrieving a web site is based on a search term provided by a web searcher. After identification of a web site on the basis of the search term, the web searcher associates a rating with the web site reflective of the degree of association of the web site to the search term according to the web searcher. The rating is stored in association with an identifier of the web site, the search term, and an identifier of the web searcher. Subsequent searching by the web searcher on the search term results in display of web sites rated above a high threshold, web sites rated by others with weighted average rating above a low threshold, and web sites identified by third-party search engines on the basis of the search term.

### PRIORITY

The present application claims priority from the U.S. Provisional Patent Application No. 60/668,409, which is hereby incorporated herein by reference in its entirety.

### TECHNICAL FIELD AND BACKGROUND ART

The present invention relates to searching for a web site, and, more particularly, to searching for a web site on the basis of a rating for the web site.

It is known in the prior art to search for web sites on the basis of a search term supplied by a web searcher and to present the web sites in an order determined by computer rating of the web site content. The web searcher furnishes search terms to a search engine such as Yahoo™ or Google™ and the search engine returns web sites containing the search terms to varying degrees. Web sites rated most appropriate are at the top of a list and web sites rated least appropriate at the bottom. A web site rating may be based on keywords, links, or on other methods. For example, rating may determined not just by the extent that web site contains the search terms, but also by the number of other web searchers who have accessed the web site based on a search using the search terms. Further, a rating can be based on number of links to the site, the amount of time users stay on the site, or the number of times users click the site in listings.

Web sites identified to the web searcher are often large in number, requiring either additional effort to further identify appropriate web sites or time to search on the basis of additional search terms to reduce the size of the list. Use of additional search terms risks losing appropriate web sites which lack the additional terms.

### Summary of the Invention

In one aspect of the invention, there is method of categorizing a web site including the steps of providing a search term from a web searcher, identifying the web site to the web searcher on the basis of the search term, associating a rating with the web site where the rating provided by the web searcher is reflective of the degree of association of the web site to the search term according to the web searcher, and storing the rating in association with an identifier of the web site, the search term, and an identifier of the web searcher. The web searcher rating may be stored separately from the web site information which may include at least one of a URL, a title, and a web site description.

Other categorizing embodiments may include the steps of associating a demographic group with the web searcher, updating a demographic group rating of the web site to include the rating of the web searcher, and storing the updated demographic group rating in association with the identifier of the web site and the search term. The demographic group rating may be an average of the ratings of the web site for the demographic group and may be stored separately from the web site information.

Additional categorizing embodiments may include the steps of updating a general rating of the web site to include the rating of the web searcher and storing the updated general rating of the web site in association with the identifier of the web site and the search term. The general rating may be an average of all ratings of the web site for the search term and may be stored separately from web site information.

In another aspect of the invention, there is a method for retrieval of a rated web site including the steps of providing a search term, indentifying primary web sites, and displaying the primary web sites having ratings above a high threshold in descending order of the ratings. The primary web sites are rated by the web searcher on the basis of the search term provided by the web searcher.

Certain retrieval embodiments may include the steps of identifying secondary web sites on the basis of the search term, calculating a weighted average rating for each secondary web site, and displaying the secondary web sites, in descending order of weighed average rating, below the displayed primary web sites. Each identified secondary web site may be associated with a general rating above a low threshold where the general rating is an average of the ratings for each identified secondary web site.

Further retrieval embodiments may include the steps of calculating a weighted administrative rating, a weighted web searcher rating, and a weighted average rating for each secondary web site, where the weighted average rating is the sum of the weighted administrative rating and the weighted web searcher rating for each secondary web site. The weighted administrative rating may be the product of an administrative rating and an administrative weight. If a secondary web site lacks an administrative rating, the default administrative rating may be a neutral rating, possibly 5. The weighted web searcher rating may be the product of the general rating and a web searcher weight where the sum of he administrative weight and the web searcher weight is 1.

Additional retrieval embodiments may include the steps of providing the search term supplied by the web searcher to a secondary search engine, identifying tertiary web sites on the basis of the search term by the secondary search engine, and displaying the tertiary web sites below the secondary web sites. In other retrieval embodiments, the web searcher may open and rate the tertiary web site.

Other retrieval embodiments may include the steps of identifying secondary web sites on the basis of the search term, calculating a weighted average rating for each of the secondary web sites, and displaying the secondary web sites, in descending order of weighted average rating below the displayed primary web sites. Each identified secondary web site may be associated with a demographic group and a demographic group rating above a low threshold where the demographic group rating may be an average of the ratings for each identified secondary web site associated with the demographic group.

Still other retrieval embodiments may include the steps of calculating a weighted administrative rating, a weighted web searcher rating, and an weighted average rating for each secondary web site where the weighted average rating is the sum of the weighted administrative rating and the weighted web searcher rating. The weighted administrative rating may be the product of an administrative rating and an administrative weight for each secondary web site. If a secondary web site lacks an administrative rating, the default administrative rating may be a neutral rating, possibly 5. The weighted web searcher rating may be the product of the demographic group rating and a web searcher weight where the sum of he administrative weight and the web searcher weight is 1.

Still additional retrieval embodiments may include the steps of providing a search term from a web searcher to a secondary search engine, identifying tertiary web sites on the basis of the search term by the secondary search engine, and displaying the tertiary web sites below the secondary web sites. In other retrieval embodiments, the web searcher may open and rate the tertiary web site. The demographic group of the web searcher may include the age and/or the sex of the web searcher.

In an additional aspect of the invention, there is a method of categorizing a web site that includes the steps of providing a search term from a web searcher, identifying the web site to the web searcher on the basis of the search term, associating a rating provided by the web searcher, a lower target rating, and upper target rating with the web site, storing the rating in association with an identifier of the web site, the search term, and an identifier of the web searcher if the rating provided by the web searcher is greater than the lower target rating and is less than the upper target rating. The rating provided by the web searcher may be reflective of the degree of association of the web site to the search term according to the web searcher.

In a still further aspect of the invention, there is a method of categorizing a web site that includes the steps of providing a search term from a web searcher, identifying the web site to the web searcher on the basis of the search term, associating a rating provided by the web searcher, determining if the web searcher had previously rated the web site, and storing the rating in association with an identifier of the web site, the search term, and an identifier of the web searcher and in replacement of a previous rating of the web site provided by the web searcher.

### BRIEF DESCRIPTION OF THE DRAWINGS

The foregoing features of the invention will be more readily understood by reference to the following detailed description, taken with reference to the accompanying drawings, in which:

FIG. 1 is a flow chart illustrating one embodiment of the invention where web sites are rated.

FIG. 2 is an illustrative screenshot presented to a web searcher in connection with rating a web site.

FIG. 3 is a flow chart illustrating an embodiment of the invention where web sites are retrieved, in part, on the basis of web site ratings.

FIG. 4 is an illustrative screenshot presented to a web searcher in connection with specifying the elements of a web site search.

### DETAILED DESCRIPTION OF SPECIFIC EMBODIMENTS

In embodiments of the present invention, after a search engine performs a search, a web searcher is presented with a list of sites that the search engine deems appropriate. After the web searcher selects a site by clicking on it, the site is displayed in the bottom pane of an HTML frames page. In the top frame, the web searcher is presented with the option to select a rating for the site to indicate how appropriate the site is for the keywords used. The rating may be from 1 through 10, with 1 indicating that the site is inappropriate and a 10 indicating that the site is very appropriate.

The rating that a web searcher selects for a site determines how and whether the site is displayed in the future. A high threshold value, for example, 8, and a low threshold value, for example, 3, may be set in the search engine to determine certain actions that may be taken for ratings at or above the high threshold and at or below the low threshold.

Web sites rated at or above the high threshold by a user for a given keyword may be presented first when the web searcher searches on that keyword again. As a result, web sites for which the web searcher has indicated a strong preference are listed first. Presentation of web sites in this manner functions as a simplified bookmark system.

If a web searcher decides that a web site is no longer appropriate, he may simply rate the site below the low threshold to remove it from his personal search list. Web sites rated at or below the low threshold by a web searcher for a given keyword may not be displayed. The web searcher may use these ratings to indicate that he does not wish to see a particular site again Web sites rated between the high and low thresholds may be displayed using a standard listing method.

In addition to web site ratings given by web searchers, web sites may also be associated with administrative ratings assigned by administrators selected from a group of web searchers. Administrative ratings work just as user ratings work, but they are stored separately and may be given greater weight than web searcher ratings. Through use of administrative ratings, for more popular queries, the administrators tailor the results of a web search by using web sites that they have researched to be appropriate. Administrative ratings may also be used to curb abuse. Administrators may rate down web sites employing abusive methods to obtain higher ratings.

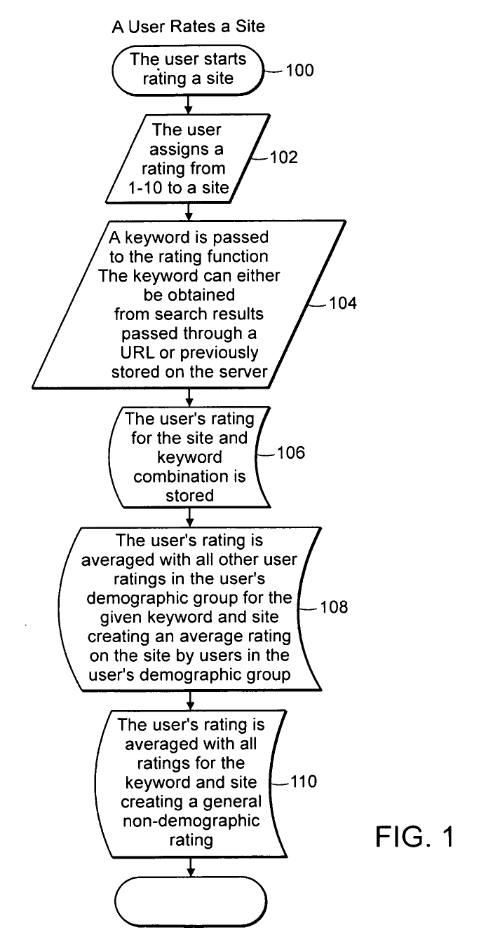

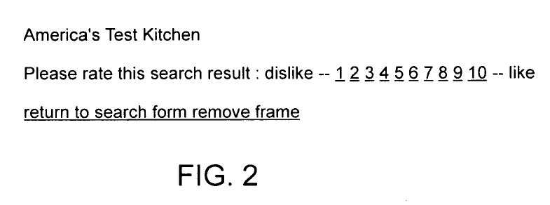

FIG. 1 contains a flow chart illustrating an aspect of the invention where web searcher ratings of web sites are compiled. Upon viewing a web site identified by a search engine on the basis of criteria such as a search term or keyword furnished by the web searcher 100, the web searcher assigns a rating to the site 102. A rating of 1 may indicate minimal relevance to web searcher, while a rating of 10 may indicate direct relevance. FIG. 2 illustrates an exemplary screenshot associated with rating the result of a search using the search term “America's Test Kitchen.” The rating is stored together with the search term, an identifier of the web site, and an identifier of the web searcher 106. The keyword is then passed to the rating function 104. If the web searcher furnished demographic information to the search engine, such as age and sex, the web searcher rating is averaged with the ratings of others with the same demographic profile as the web searcher to create a demographic group rating of the web site 108. The rating of the web searcher is averaged with other web searchers who have rated the web site to create a general non-demographic rating of the web site 110.

Measures may be taken to enhance the security of the ratings. The web site ratings may be stored separately from the search term and the list of web sites associated with the search term to increase the difficulty of artificially boosting the rating of a specific web site. Minimum and maximum web site ratings may be established to prevent assigning an inappropriate bad or good rating to a web site. Prior to entering a rating for a web site identified on the basis of the search term, a check may be conducted to determine if the web searcher has previously rated the web site for the search term. If the web searcher has already entered a rating, the most recent rating may be substituted for the existing rating to prevent distortion of the general and demographic group ratings by fraudulent accumulation of repetitive ratings.

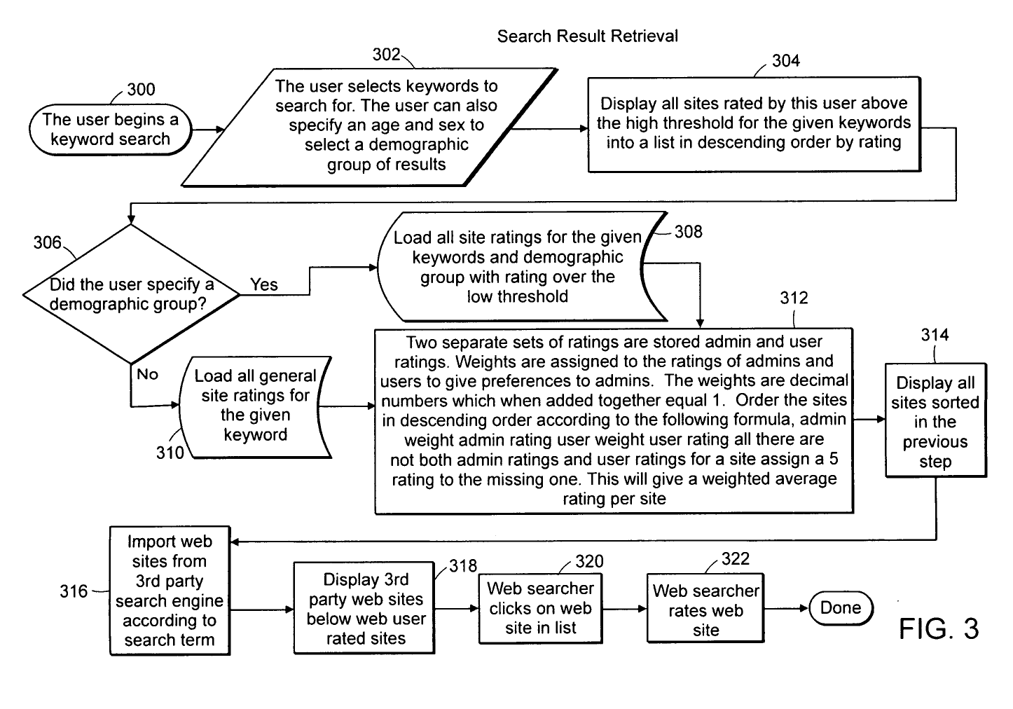

FIG. 3 illustrates an embodiment of a search process for retrieval and presentation of web sites on the basis of web searcher ratings. The web sites presented on the basis of a search may be of several categories, for example, primary, secondary, and tertiary. Primary web sites have been rated by the web searcher for the web search term. Secondary web sites have been rated by others for the search term. Tertiary web sites have been identified on the basis of just the search term.

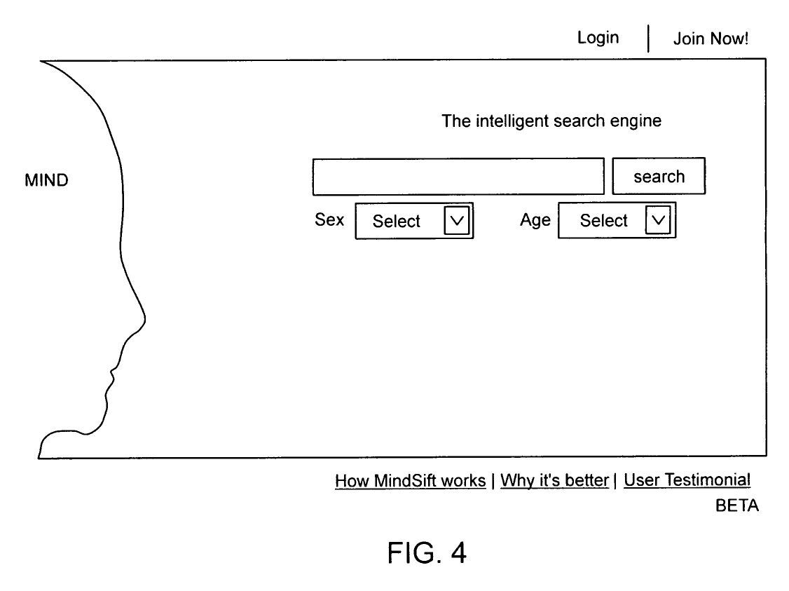

The web searcher enters the search term 300 and, if desired, the demographic group 20 for which the search results are to be presented 302. The web searcher may elect to receive results from any demographic group. This allows a parent, for example, to lookup what music is most popular with teen females. FIG. 4 illustrates an exemplary screen shot that may be employed in connection with the specification of a search term and a demographic group by a web searcher.

First, the high and low threshold web sites are retrieved by searching the database of rated web sites for all sites rated by the web searcher 304. A list of web sites already listed or excluded is maintained to keep duplicate sites from being displayed. All web sites rated by the web searcher at or above the high threshold, i.e., primary web sites, are displayed first, in order of rating. All sites rated at or below the low threshold are added to the list of sites to be excluded from further listing.

If the web searcher, as determined at step 306, has specified a web search on the basis of both the search term and a demographic rating, web sites associated with the search term and the demographic group and having demographic group ratings in excess of a low threshold are identified 308. If the web searcher has only specified a web search on the basis of the search term, web sites associated with the search term and having a general rating in excess of the low threshold are identified 310. The identified web sites are secondary web sites.

Prior to display of secondary web sites, a weighted average rating is associated with the secondary web sites 312. In addition to a demographic group or a general rating associated with the web site, there is also an administrative weight and, possibly, an administrative rating. The weighted average rating is the sum of the product of the demographic group or general rating for the web site and the web searcher weight and the product of the administrative rating for the web site and the administrative weight. The administrative weight and the web searcher weight add to 1. In the absence of an administrative rating, the administrative rating defaults to a neutral rating, for example, 5. This may implicitly give a preference to web sites that have been rated by administrators when the weight given to administrative ratings is higher than the weight given to user ratings.

The secondary web sites are listed in descending order according to their weighted average rating and displayed below the primary web sites 314. Web sites with a weighted average rating below the low threshold are excluded from this listing.

Additional web sites may be identified on the basis of the search term alone 316. Search on the basis of the search term may be conducted by third-party search engines such as Gigablast™, Yahoo™, and Google™. Web sites identified on the basis of the search term alone are tertiary web sites and are displayed below the secondary web sites 318.

A web searcher selecting a tertiary web site 320 to examine is given the opportunity to rate that site 322, to have the web site incorporated into the database of rated web sites, and to have the examined and rated web site considered subsequently as a primary web site.

The described embodiments of the invention are intended to be merely exemplary and numerous variations and modifications will be apparent to those skilled in the art. All such variations and modifications are intended to be within the scope of the present invention as defined in the appended claims.

1. A method of categorizing a web site, the method comprising:
providing a search term from a web searcher;
identifying the web site to the web searcher on the basis of the search term;
associating a rating with the web site, the rating provided by the web searcher and reflective of the degree of association of the web site to the search term according to the web searcher; and
storing the rating in association with an identifier of the web site, the search term, and an identifier of the web searcher.

2. The method of claim 1, further including:
storing the web searcher rating separately from web site information.

3. The method of claim 2, wherein the web site information includes at least one of a URL, a title, and a description for the web site.

4. The method according to claim 1, the method further including:
associating a demographic group with the web searcher;
updating a demographic group rating of the web site to include the rating of the web searcher, the demographic group rating being an average of ratings of the web site for the demographic group and the search term; and
storing the updated demographic group rating in association with the identifier of the web site and the search term.

5. The method of claim 4, further including:
storing the demographic group rating separately from web site information.

6. The method of claim 5, wherein the web site information includes at least one of a URL, a title, and a description for the web site.

7. The method according to claim 4, the method further including:
updating a general rating of the web site to include the rating of the web searcher, the general rating being an average of all ratings of the web site for the search term; and
storing the updated general rating of the web site in association with the identifier of the web site and the search term.

8. The method of claim 7, further including:
storing the general rating separately from web site information.

9. The method of claim 8, wherein the web site information includes at least one of a URL, a title, and a description for the web site.

10. A method for retrieval of a rated web site, the method including:
providing a search term, the search term provided by a web searcher;
identifying primary web sites, each rated by the web searcher, on the basis of the search term; and
displaying the primary web sites having ratings above a high threshold in descending order of the ratings.

11. The method of claim 10, the method further including:
identifying secondary web sites on the basis of the search term, each identified secondary web site associated with a general rating above a low threshold, the general rating for each identified secondary web site being an average of the ratings for each identified secondary web site;
calculating a weighted average rating for each secondary web site; and
displaying the secondary web sites, in descending order of weighted average rating, below the displayed primary web sites.

12. The method of claim 5, the method further including:
calculating a weighted administrative rating for each secondary web site;
calculating a weighted web searcher rating for each secondary web site; and
calculating a weighted average rating for each secondary web site as the sum of the weighted administrative rating and the weighted web searcher rating.

13. The method of claim 12, wherein the weighted administrative rating is the product of an administrative rating and an administrative weight for each secondary web site.

14. The method of claim 13, wherein the default administrative rating for a secondary web site lacking an administrative rating is a neutral rating.

15. The method of claim 14, wherein the neutral rating is 5.

16. The method of claim 12, wherein the weighted web searcher rating is the product of the general rating and a web searcher weight for each secondary web site.

17. The method of claim 16, wherein the sum of the administrative weight and the web searcher weight for each secondary web site is 1.

18. The method of claim 11, the method further including:
providing the search term to a second search engine, the search term provided by the web searcher;
identifying tertiary web sites on the basis of the search term by the second search engine; and
displaying the tertiary web sites below the secondary web sites.

19. The method of claim 18, the method further including:
opening of the tertiary web site by the web searcher; and
rating of the opened tertiary web site by the web searcher.

20. The method of claim 10, the method further including:
identifying secondary web sites on the basis of the search term, each identified secondary web site associated with a demographic group and a demographic group rating above a low threshold, the demographic group rating for each identified secondary web site being an average of the ratings for each identified secondary web site associated with the demographic group;
calculating a weighted average rating for each of the secondary web sites; and displaying the secondary web sites, in descending order of weighted average rating, below the displayed primary web sites.
